(19) United States
(12) Patent Application Publication
(10) Pub. No.: US 2004/0185569 A1
(43) Pub. Date: Sep. 23, 2004

(54) Controlling microdrop dispensing apparatus

(76) Inventors: Ronald A. Zweifel, Naperville, IL (US); Christopher M. Hahn, Decatur, IL (US)

Correspondence Address: JENKENS & GILCHRIST, P.C., 225 WEST WASHINGTON, SUITE 2600, CHICAGO, IL, 60606, US

(21) Appl. No.: 10/746,039

(22) Filed: Dec. 23, 2003

Related U.S. Application Data
(63) Continuation-in-part of application No. 09/776,427, filed on Feb. 2, 2001, now abandoned.

(51) Int. Cl. G01N 35/00

(52) U.S. Cl. 436/43; 422/100

(57) ABSTRACT

A method and apparatus for preventing or limiting damage to capillaries used to dispense microdrops measures the voltage produced by a piezoelectric transducer when the capillary contacts a solid surface or the phase shift occurring when the piezoelectric transducer is operated at its resonant frequency. After distinguishing the voltage created from such contact from the voltage produced from unrelated random sources, corrective action is taken, in one aspect by stopping the relative movement of the capillary and the surface being contacted. The method and apparatus may also be employed to determine the position of a solid or liquid surface. In one embodiment, the method and apparatus of the invention is used to detect contact of the capillary with very small liquid droplets.

This is a continuation-in-part of U.S. Ser. No. 09/776,427 filed Feb. 2, 2001.

### BACKGROUND OF THE INVENTION

The invention relates generally to apparatus for depositing small droplets of liquid. More particularly, the invention has application to the type of apparatus discussed in, for example, in PCT publication WO 98/45205, assigned to the Packard Instrument Company, which describes equipment capable of aspirating a liquid and dispensing it in droplets having a volume in the range of 5 to 500 picoliters. Such small droplets are ejected from the tip of a capillary by applying a voltage pulse to a piezoelectric transducer surrounding the capillary, producing a force sufficient to dispense one or a series of small droplets having a diameter similar to that of the opening of the capillary. Although there are various end uses for such equipment, it is particularly useful in connection with microscale chemical and biological analysis. The published PCT patent application suggests means for cleaning the tip of such capillaries which may easily become clogged. The present invention solves another problem to which the equipment may be subject, namely damage to the capillaries during the use of the apparatus. In addition, the invention has application to determining the position of a solid or a liquid surface.

In a typical operation, the tip of a capillary is moved into contact with liquid in a container and the liquid is aspirated, after which the capillary is moved to another location, where the liquid is dispensed in one or more droplets as desired. Then the capillary may be moved to another location, where additional droplets are dispensed or to a wash station where the capillary is cleaned before being used to aspirate and dispense another sample of liquid. It is also possible to maintain the capillary in one location and to move the containers or the surfaces which receive the liquid droplets under the capillary. Generally, such operations require the capillary to be moved vertically downward so that the tip is brought close to the bottom of the sample container or surface and then moved upwardly so that the sample container or surface can be exchanged for another. The capillaries are commonly made of glass and can easily be broken if they contact a sample container or surface. This not only interrupts the process being performed, but it is costly to replace the capillaries and the associated piezoelectric transducers. The breakage problem is multiplied when the number of capillaries is increased or the sizes of the associated sample containers and surfaces are decreased relative to the size of the capillaries.

For most practical applications of this technology the process must be automated. It can be appreciated that if the tip of a capillary is brought to within about 0.4 mm of the bottom of a sample container or another surface, that positioning the tip is difficult to do manually and damage to the tips could easily occur. If multiple capillaries are used, the damage potentially could be very great. Small errors in the positioning of the sample containers or droplet receiving surfaces can cause a capillary to unintentionally contact the wall of the sample container or the surface and to break. This may result from errors in programming, but even if the operator of such equipment has accurately programmed the movement of the capillaries for the necessary movements in three dimensions, it is still possible for errors in positioning of the sample containers or surfaces to lead to expensive damage to the capillaries.

Frequently, the microdispensing apparatus will be used to aspirate samples from a microplate having an array of small wells which hold liquid. A common size is a 96 well plate, measuring about 80 by 120 mm and having round sample wells having a diameter of about 6.5 mm. However, more recently plates having 384 and 1536 wells have become available. These have the advantage of further reducing the volume of the liquids needed to fill a well. However, these newer plates have the disadvantage of having sample wells which are much smaller than those in the 96 well plates. For example, the 384 well plate will have square wells with each side only 3.6 mm, while a 1536 well plate will have square wells with each side less than 1.5 mm. When one considers that the outside dimension of a typical capillary is only about 1 mm, it is evident that there is very little room for error in programming the three-dimensional movement of the capillaries or in positioning of the sample containers or surfaces. Therefore, the present inventors have addressed the problem of preventing or at least minimizing the possibility of contact between the capillaries and the sample containers or surfaces, so that the microdrop dispensing equipment can be used commercially with little or no downtime resulting from damage to the delicate capillaries. Their solution to the problem is described below in detail. In one broad aspect their invention involves using the capillary with its piezoelectric transducer to detect contact with the solid surfaces, such as sample wells or droplet receiving surfaces and taking corrective action to prevent or at least to limit damage to the capillaries.

The invention may also be applied to detect the location of a solid or a liquid surface. In one aspect, the invention can be used to detect contact with very small droplets and then to determine the change in resonant frequency resulting from liquid added to the capillary.

### SUMMARY OF THE INVENTION

In one aspect, the invention is a method of detecting when a capillary for dispensing liquids by action of a piezoelectric transducer comes in contact with a surface. The electrical voltage created by the piezoelectric transducer in response to such contact is detected and corrective action can be taken to avoid breakage of the capillary. In a related aspect, the electrical voltage change created when the capillary touches a surface is used to establish the position of a surface, either liquid or solid surface.

In another embodiment, the invention is a method of detecting when a capillary for dispensing liquids by action of a piezoelectric transducer comes into contact with a surface, in which the piezoelectric transducer surrounding the capillary is driven with a low oscillating voltage at its resonant frequency to establish a signal corresponding to the capillary and an inverted signal is created in phase with the signal of the capillary as a reference. When the capillary contacts a surface, the phase shift of the capillary signal relative to the reference signal is detected, and triggers corrective action. In a related aspect, the phase shift just described is used to establish the position of a surface, either liquid or solid. The phase shift can be readily detected by summing the voltage potentials and detecting the voltage change. Alternatively, the signal corresponding to the capillary and the reference signal are not inverted, but are congruent and in phase until contact is made with a surface, causing the phase shift.

In another aspect, the invention is an apparatus for dispensing microdrops of liquid by the action of a piezoelectric transducer in which the transducer is used to detect the contact with a solid surface by the capillary used to dispense the microdrops and to prevent damage to the capillary, or alternatively to establish the position of a surface, either liquid or solid. In one embodiment, the voltage produced when contact is made with a surface is made is used to detect contact. In another embodiment, the capillary is driven at its resonant frequency to establish a capillary signal, which is compared with an inverted signal as a reference and the phase shift between the signals resulting from contact of the capillary is detected. Preferably, the phase shift is detected by summing the voltage potentials and detecting the voltage change.

In still another aspect, the invention is the improvement in a capillary equipped with a piezoelectric transducer for expelling small droplets of liquid from the tip of the capillary when a voltage is applied to the piezoelectric transducer, and in which the transducer is used to detect contact with a surface. In one embodiment, the contact with a surface creates a voltage from the force applied to the transducer by contact with a surface. In another embodiment, the capillary is driven at its resonant frequency to establish a capillary signal, which is compared with an inverted, or congruent, reference signal and the phase shift between the signals produced by contact is detected. Corrective action can be taken typically by stopping movement of the capillary to prevent damage to the capillary.

Alternatively, the technique can be used to establish the position of a solid or liquid surface. In a preferred embodiment, the method is used to detect the contact of a capillary tip with very small droplets of liquid and then to determine the new resonant frequency of the capillary tip.

In one embodiment, the contact of a piezoelectric dispensing tip with a liquid surface is detected by measuring the phase shift between the new resonant frequency of the dispensing tip and a reference frequency corresponding to the previous resonant frequency of the dispensing tip prior to contact with the liquid. The reference frequency is then adjusted to match the new resonant frequency of the dispensing tip.

In a preferred embodiment, the resonant frequency of the dispensing tip is determined by adjusting a voltage controlled oscillator (VCO) that provides an reference sine wave frequency for comparison with the resonant frequency of the dispensing tip. The reference frequency and the resonant frequency of the dispensing tip are amplified, converted to square waves and compared in an exclusive OR gate. When the reference and dispensing tip frequencies are in phase the OR gate produces no signal. When the two frequencies are not in phase a series of pulses is produced, that are counted by a binary counter, converted to an analog DC voltage signal and used to adjust the reference frequency of the VOC. The process continues until the reference and dispensing tip frequencies are equal.

### BRIEF DESCRIPTION OF THE DRAWINGS

FIG. 1 is a graph of the voltage generated when a capillary hits a solid surface in the vertical (Z) direction.

FIG. 2 is a graph of the voltage generated when a capillary hits a solid surface in the horizontal (X-Y) plane.

FIG. 3 is a graph of the voltage generated in a second type of contact of a capillary with a solid surface in the horizontal (X-Y) plane.

FIG. 4 is a graph of the unfiltered voltage generated by the excursion when the capillary contacts a solid surface plus an overlay of the amplified voltage produced by the capillary contact. The random noise has not been filtered.

FIG. 5 is a block diagram of the control systems used to operate the micro dispensing apparatus and to prevent breakage of the capillary.

FIG. 6 is a block diagram of the method for detecting contact with the surface of a liquid.

### DESCRIPTION OF THE PREFERRED EMBODIMENTS

Microdrop Dispensing Apparatus

As mentioned above, the invention has particular relevance to apparatus used to dispense very small drops of liquid, such as those described in detail in PCT publication WO 98/45205 by the Packard Instrument Company. The microdrop dispensing systems will be described briefly here. For more details, reference may be made to the published patent application. The invention is not limited to the specific equipment described there, but may be applied to other equipment employing piezoelectric transducers to dispense drops of liquid.

Two types of liquid dispensing systems are described in WO 98/45205, both of which employ a capillary tube terminating in a smaller dispensing tip having an internal diameter of about 25 to 100 microns and capable of dispensing drops of liquid having a volume of about 5 to 500 picoliters. By surrounding the capillary tube with a piezoelectric transducer, it is possible to apply a voltage pulse, e.g. between about 40 and 300 volts to the transducer, which is mechanically deformed, compressing the capillary and expelling a drop of liquid. When the voltage is applied for a very short time a single drop is expelled. If the voltage is applied with a frequency up to about 1,000 Hz, a series of droplets can be expelled to provide the volume of liquid which one wishes to dispense.

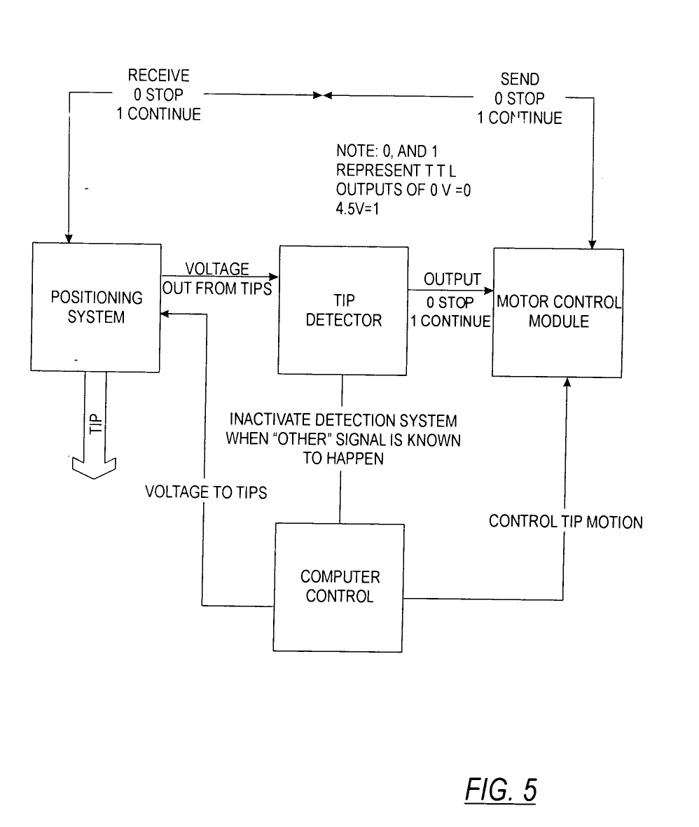

The published patent application describes generally the operation of a robotic system which positions the microdrop dispensing capillary tip over a sample liquid in its container, such a microplate shown in FIG. 5 of the application. The tip is moved until it makes contact with the surface of the liquid in the container, which contact may be sensed by a capacitive liquid level sensing system, so that the movement of the capillary is stopped and the liquid is aspirated into the capillary. Then, the capillary can be moved to another location and the aspirated liquid dispensed as desired. The published patent application also describes an optical method of positioning the capillary tip within each well of a microplate.

While the description herein is principally concerned with apparatus in which the capillary is moved from one location to aspirate liquid and to a second location to dispense microdrops of the liquid, it should be understood that the opposite arrangement is feasible and may be preferred for large scale commercial use. That is, in the simplest form, a single capillary is mounted on a moveable support and moved horizontally in the X-Y plane and vertically in the Z direction into a first location, such as the well of a microplate to aspirate a liquid and then to a second location, such as a planar surface on which microdrops of the liquid are dispensed. Thus, the capillary moves while the liquid containers e.g. a sample well or the surface which receives the microdrops are stationary. Alternatively, the capillary could be stationary and the container and surface could be moved under the capillary, which is moved only in the vertical direction (Z). Such an alternative arrangement may be desirable particularly when multiple capillaries are mounted in an array and it is more convenient to move the containers, sample plates and surfaces than to move the array of capillaries. It is of course possible to use an apparatus capable of moving each of the capillaries, the containers, the sample plates, and the surfaces independently for maximum flexibility of operation. Each embodiment is subject to the problems discussed above, since no matter which is used, movement may bring a capillary into contact with a container or a surface, resulting in damage to the capillary.

In practice, it is not desirable to carry out such movements manually, using visual observation by the operator. To assure accuracy in repetitive steps of aspirating and dispensing liquids, computer control of the movements of the capillaries generally will be provided. The operator of the apparatus will instruct the computer to carry out a series of movements intended to transfer liquid from a container and to dispense it into a second container or onto a surface such as a glass slide. For example, a capillary could be instructed to move to a first well containing liquid, aspirate a predetermined amount of the liquid, move to a predetermined location over a glass slide, and dispense a single drop of the liquid there, then move to other positions on the same slide and dispense additional drops of liquid. After dispensing the desired amount of liquid, the capillary tip could be instructed to move to another location where it would be washed before the cycle is repeated. It will be appreciated that such a sequence of movements will take place in three dimensions, usually called X and Y defining the position in a horizontal plane and Z defining the position in the vertical direction. Since the capillaries are very small, one can appreciate that they can be easily damaged if, during their travels in the X, Y and Z directions, they come in contact with an obstacle, such as the well of a microplate or the surface of a glass slide. While it might be thought that the computer control could eliminate concern over such contacts, errors can occur leading to damage of the capillaries. These errors are generally of two types, the first, errors in programming of the computer control and the second, errors in positioning of the containers or the slides. The present inventors cannot prevent errors made by others, but they have developed a method for limiting or preventing the damage to capillaries which could otherwise occur.

The nature of the problem can be understood more easily when the dimensions of the capillary and the associated containers and surfaces and the distance between them are considered. The usual capillary has an internal diameter of about 300-800 microns and an external diameter of about 500-1,000 microns (0.5-1 mm). At the tip the capillary is reduced to an external diameter of about 100 microns and the dispensed droplets are even smaller. The 0.5-1.0 mm o.d. capillary will be inserted into the well of a microplate which has a diameter of no more than 6 mm and, often is as small as 2.6 mm square, sometimes with a 1,536-well microplate a wall of about 1.5 mm square. The capillary tip may approach the bottom of the well within about 0.4 mm or 400 microns, or a similar distance from a glass slide on which it is to deposit a single drop. There is very little room for error in positioning the capillary and experience has shown that damage to the capillary is frequent enough to present a significant problem. Since the capillaries are very small and generally made of glass, very little force is required to break them. Thus, any contact between a capillary and any solid surface which could result in breakage must be detected quickly and corrective action taken at once.

While the above discussion considered the movement of a single capillary, when the microdrop dispensing method is applied on a large scale commercially, it is probable that many dispensing capillaries will be in operation simultaneously. For example, four up to a number equal to the number of containers from which liquid is to be aspirated. Therefore, potentially all of the many capillaries could be broken at the same time by a positioning error. Since each one is expensive, breaking many at one time must be prevented, as is possible with the present invention.

Detecting and Preventing Damage to Capillary Tips

Each capillary dispenses one or more drops when a piezoelectric transducer surrounding the capillary is activated by applying a brief voltage pulse, thereby compressing the capillary tube and expelling a drop for each pulse. The piezoelectric transducer can operate in a reverse manner, that is, it can create an electrical voltage if it is mechanically strained, a principle which is used for applications such as record players, cigarette lighters, igniters on barbecue grills and some microphones and speakers. The voltage produced by a piezoelectric transducer is related to the force applied to the transducer. In the present invention, the voltages generated and detected are generally quite small compared to the voltage used to compress a capillary tube and expel a liquid droplet, e.g., about 40 to 300 volts. Thus, while it might be anticipated that a capillary with a piezoelectric transducer could produce a voltage if the tip contacts a solid surface, it is not evident that the voltage could be distinguished from the random “noise” resulting from unrelated sources, so that it can be used to prevent breaking the tip, or to establish the position of a surface. The present inventors have found that to be possible, with the methods and apparatus to be described.

When the piezoelectric transducer is distorted mechanically so as to compress the capillary and dispense a liquid droplet, a relatively high voltage is used, as previously discussed. In contrast, when a capillary touches a solid surface during operation of the microdrop dispensing apparatus, a very small voltage of at least 10 millivolts (0.01 volt) is typically produced. At the same time, the capillary is constantly producing “noise”, that is, voltage produced by the transducer from mechanical forces introduced by the movement of the capillary, the driving motors, external vibrations, and the like. Thus, if one measures the voltage being produced by the piezoelectric transducer while it is not dispensing droplets, it is found that an irregular random voltage is always being produced, typically of a similar order of magnitude as the voltage produced by contact with a surface. Such noise would not ordinarily be of concern and would be small enough in size as to have no significant effect on the dispensing of droplets. However, it is of a magnitude which can mask the voltage produced by contact of the capillary with a solid surface, especially if the contact is slow, as it often is when contact occurs in the X-Y (horizontal) plane. Vertical contact in the Z direction often produces a more pronounced reaction. Examples of such contacts between a capillary and the wall of a container and between the tip of the capillary in the horizontal plane and a solid surface in the Z direction are shown in the Figures.

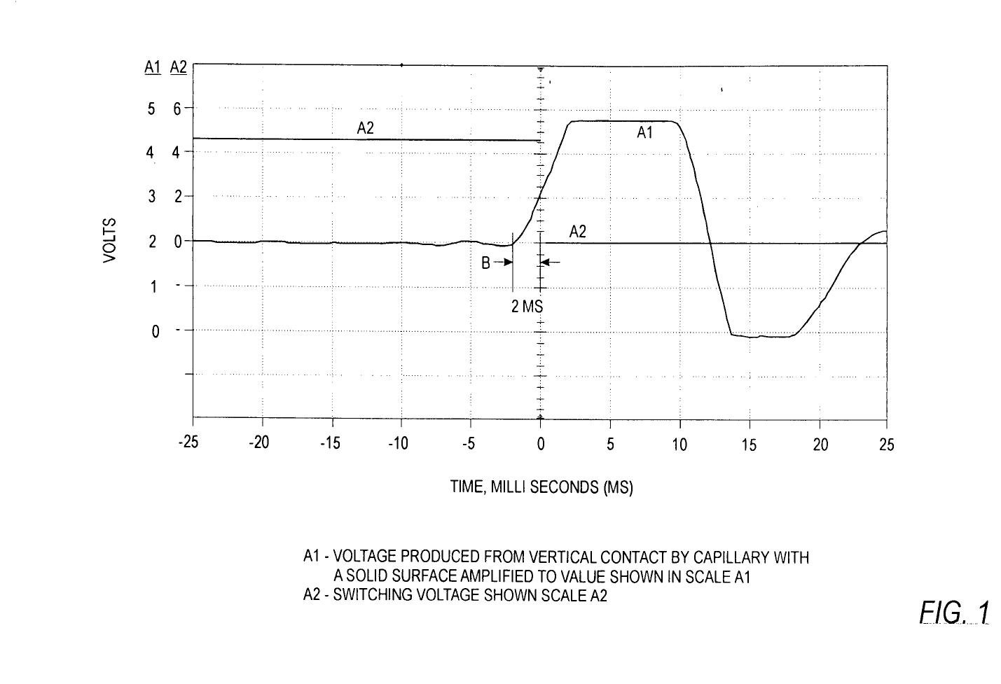

In FIG. 1, a “hard” contact was made between a capillary and a solid surface in the Z (vertical) direction. The reference voltage is shown as a baseline bias voltage of two volts. When the capillary touches a surface a voltage change is produced (A1) from the strain in the piezoelectric transducer. The actual voltage has been amplified to show the variation from the baseline bias voltage of 2 volts.

A2 shows the voltage of about 4.5-5 volts used to establish a baseline for determining whether contact has occurred. When the voltage rise caused by the contact of a capillary reaches the switching threshold, the switching voltage is dropped to zero, causing the motor control module (see FIG. 5) to stop movement of the capillary to prevent breakage. The corrective action took place within 2 milliseconds after the voltage increase began, as shown by the voltage drop from 4.5-5 volts to zero as the controlling switch is opened.

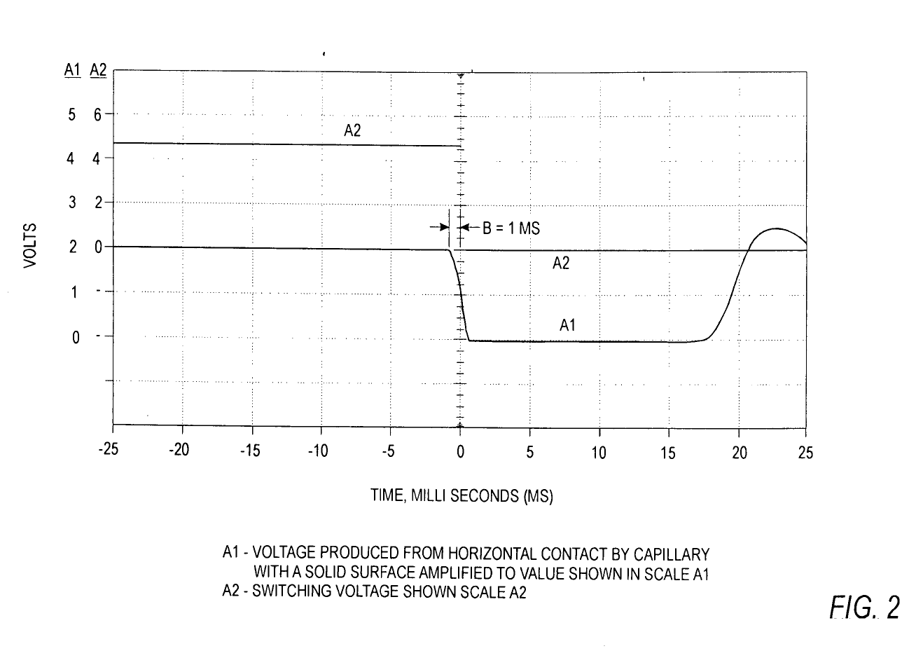

FIG. 2 illustrates the result of a capillary moving horizontally at 7.5 inches/second (190 mm/sec) coming into contact with the wall of a cell in a sample plate. As in FIG. 1, the reference voltage has been shown as a nominal bias of two volts. When the capillary touched the cell wall, a voltage change was produced and detected in about one millisecond, as can be seen on the horizontal scale, triggering corrective action. In this instance, the voltage excursion was negative, rather than positive, as in FIG. 1. Either negative or positive excursions may occur, depending on the direction of the strain on the piezoelectric transducer.

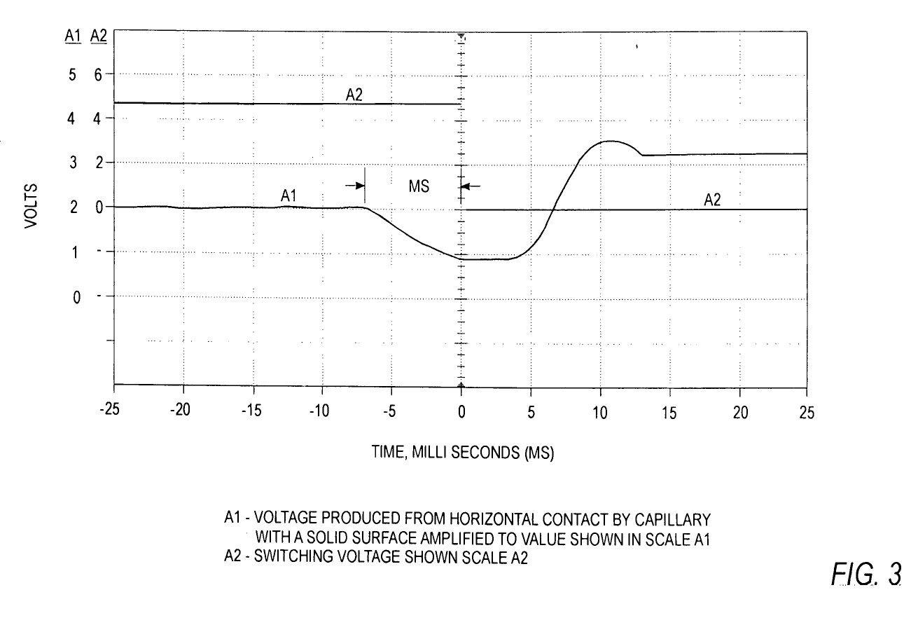

In FIG. 3, a “soft” contact was made between a capillary moving at 7.5 inches/second (190 mm/sec) and a solid surface in the X-Y plane. The voltage excursion was slower than in FIG. 2, but the result was similar. In about 7 milliseconds, the voltage excursion in A1 was detected and corrective action taken, as shown by the drop to zero voltage from the switching circuit (A2).

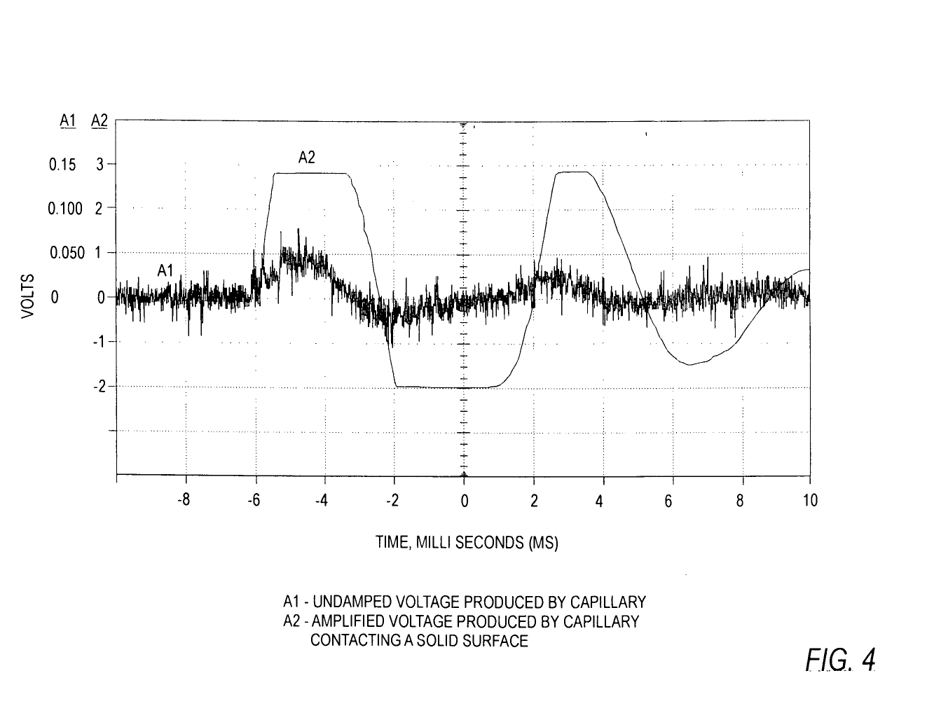

FIG. 4 shows the “raw” voltage (A1) associated with a capillary when it is being moved, but not dispensing droplets. The scale for this data is 50 millivolts per division, indicating that the random noise is typically less than ±50 millivolts. The actual voltage produced when a capillary contacts a solid surface is also small, in this Figure up to about 75 millivolts. The relatively small voltage excursion is amplified to provide a signal which is detected, as shown in the previous figures. This Figure illustrates the relationship between the actual voltage and the amplified signal. The “noise” is distributed uniformly about zero voltage and is filtered out. Only the excursion caused by contact of a capillary with a solid surface is amplified (A2).

FIG. 5 is a block diagram illustrating the controls used to position the capillaries. The “tip detector” system receives the voltage being generated by a capillary, distinguishes between “noise” and a voltage generated by the piezoelectric transducer when the capillary contacts a solid surface, sends a signal to the motor control module to stop movement of the capillary. If no voltage excursion is detected, then the tip detection system signals the motor control module to continue its normal routine.

The diagram, omitting the tip detection system, illustrates the general operation of the microdrop dispensing apparatus. A capillary (or more typically multiple capillaries) is moved to a predetermined position and one or more drops are dispensed by applying a relatively high voltage to the piezoelectric transducer surrounding the capillary. Then, the capillary is moved to the next predetermined location by the positioning system as directed by the motor control module, which is instructed by the computer which controls the overall operation of the apparatus. The computer directs application of dispensing voltage to the capillary and also inactivates the tip detection system when voltage is to be applied to the transducer or at other times, such as when aspirating liquids or cleaning the capillaries.

The above discussion relates to a method in which the voltage created when a capillary contacts a solid surface is distinguished from random “noise” and used to stop the relative movement of the capillary and a sample plate or surface with which the capillary is being used. Alternatively, the invention also includes a method in which the capillary is pulsed at its resonant frequency with a voltage which does not cause droplets to be expelled. An inverted phase is provided as a reference signal so that the two frequencies are in phase. When the capillary contacts a surface; the resonant frequency is shifted in phase from the inverted resonant frequency. By measuring the phase change relative to the inverted signal used as a reference, a signal is sent to the motor control module of FIG. 5 to stop further movement.

The resonant frequency may be determined for each capillary by increasing until the resonant frequency is reached. Then, in a preferred embodiment, an inverted or congruent signal at the resonant conditions for the capillary is created as a reference. The two are in phase with each other as long as the capillary is not touching a surface and is oscillating at its natural resonant frequency. However, when the capillary touches a surface, the oscillation of the capillary is no longer in phase with the inverted or congruent signal which had been created as a reference. Although the voltage change which results is small, the phase shift is large. One method of detecting this phase shift is to sum an inverted reference signal with the signal from the capillary. Usually, the sum of the signals cancel each other out and result in a zero voltage reading. When the phase of the capillary changes only slightly, the sum of the signals is no longer zero. The voltage change is read as being the result of the capillary touching a surface, then a signal to the motor control unit stops movement of the capillary, in a similar manner as that described for the first embodiment. In a preferred method, the reference and capillary signals are congruent and the phase shift is detected by the system described below.

Detecting the Position of Surfaces

Although the invention has a particular value in preventing capillaries from being broken during operation of a microdrop dispensing apparatus, it can also be used to detect the position of surfaces. For example, in some applications it will be necessary to position droplets precisely on the surface of a flat slide. Since the capillary tip will closely approach the surface before dispensing a droplet, it is important to know where the surface is. As noted earlier, the approach distance may be about 0.4 mm. Where multiple droplets are to be rapidly dispensed, each at a different location on a slide, knowing where the surface is positioned is important. The invention can be used to locate the surface of a slide by the voltage change when contact is made or the voltage resulting from the phase shift compared to an inverted reference as in the second embodiment. In this use, no further movement toward the surface would made, but the motor control unit could be instructed to note the position of the surface for subsequent dispensing of droplets and to proceed with the regular dispensing program.

The same general method may be used to detect the position of a liquid surface, which might be liquid in a sample well or in a container from which liquid is to be aspirated.

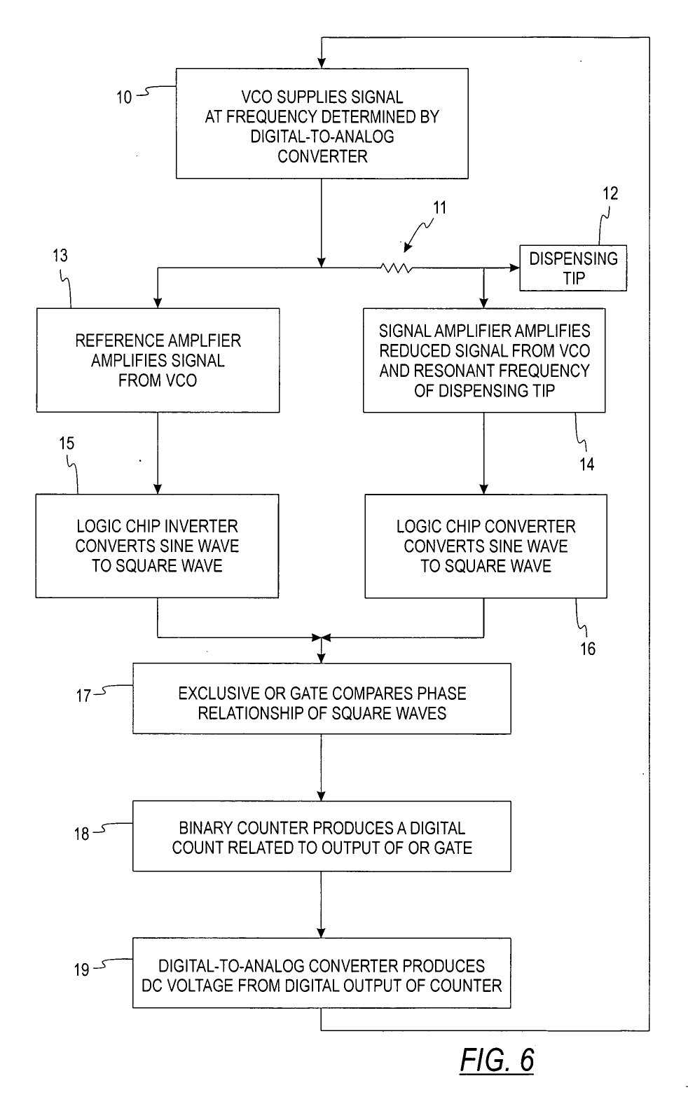

The second method described above has been found to be extremely sensitive, making it possible to detect contact of a piezoelectric dispensing tip with a very small droplet of liquid, e.g. as small as ten μL. Of course, this sensitivity means that it can be used also to detect contact with large droplets or the surface of a large amount of liquid. A problem associated with detection of liquid surfaces is that the resonant frequency of the dispensing tip is expected to change as it acquires liquid, either on its surface or by aspirating or dispensing liquid. Thus, the method of the invention must determine the changing resonant frequency of the dispensing tip as it proceeds through its programmed routine. The changes in resonant frequency may be quite small, for example, about 0.1%. But, in order to detect the next contact with the surface of a liquid, the new resonant frequency must be determined and used as the base value for the next step in the program. One method of carrying out this aspect of the invention is illustrated in FIG. 6.

The dispensing tips typically have a high resonant frequency. For example, in one embodiment where contact with small droplets is being detected, the resonant frequency of the dispensing tip is expected to be in the range of about 105 to 115 kHz. A voltage controlled oscillator (VCO) is used to supply a frequency within the expected range, beginning at the lowest frequency (105 kHz) and raising the frequency until the resonant frequency of the dispensing tip is located. At that point, no further change is made by the VCO until the dispensing tip contacts a liquid surface and the resonant frequency drops. Then, the new resonant frequency is determined by the method to be described and used as the base value for the next step in the program through which the dispensing tip moves.

To illustrate the process using the method shown in FIG. 6, assume that the initial resonant frequency of the dispensing tip (12) was 110 kHz. The VCO (10) provides that frequency to two amplifiers (13 and 14), one serves as a reference (13) and the other amplifier (14) amplifies the signal when the dispensing tip (14) is at its resonant frequency. (When not at its resonant frequency, the amplified signal is much reduced). The reference amplifier (13) receives the VCO (10) output directly, but the amplifier associated with the dispensing tip (12) receives the output after it has been reduced by the resistor (11). When the dispensing tip (12) is in resonance the output of amplifier (14) is substantially increased to correspond with the output of reference amplifier (13). When the reference and dispensing tip frequencies are equal, there is no further change in the frequency output of the VCO (10) because two amplifiers (13 and 14) supply duplicate sine waves representing the resonant frequency to the logic chip inverters (15 and 16). The square waves produced by the logic chip inverters (15 and 16) are in phase with one another and when compared in the exclusive OR gate (17), no signal is produced. When there is no signal from the exclusive OR gate (17), the binary counter (18) produces a constant output count to the digital to analog converter (19) and the DC voltage output to the VCO (10) does not change. Thus, the VCO (10) receives a constant DC voltage and makes no change in the frequency of its output to the amplifier (13 and 14).

When the dispensing tip (12) contacts a liquid surface, the resonant frequency drops and the amplifiers no longer produce matched frequencies. However, the dispensing tip amplifier (12) now has a lower output because the tip is out of phase and not in resonance. The logic chip inverter (16) associated with the dispensing tip amplifier (14) produces no signal because it receives a signal too low to produce a square wave. However, the logic chip inverter (15) associated with the reference amplifier (13) does continue to produce a signal. The exclusive OR gate (17), receiving only one signal, begins to send a pulse to the binary counter (18). The binary counter (18) begins to produce a higher count, the digital to analog converter (19) supplies an increasing DC voltage to the VCO (10), instructing it to increase its output frequency. Then, the frequency is increased by a cyclic process comparing the output of the two amplifiers (13 and 14) until the maximum frequency (e.g. 115 kHz) is reached and the binary counter is reset to its base count (e.g. zero) and the VCO produces the lowest value in its range, e.g. 105 MHz. The frequency is increased until the dispensing tip reaches resonance and the OR gate (18) ceases to produce an output. The process is repeated throughout the program through which the dispensing tip (12) moves, making it possible to continually detect the resonant frequency of the dispensing tip as it changes when the tip contacts a liquid surface. Although described here as applied to a single dispensing tip, those skilled in the art will recognize that the methods of controlling dispensing type are especially valuable when applied to an apparatus having many tips, where each may have its own resonant frequency.

In one embodiment of the circuit of FIG. 6, the VCO operates over the range of 105 to 115 kHz, which is a useful range for the dispensing tips used with the equipment of PerkinElmer Life and Analytical Sciences. The VCO may be a 1CL8038 made by Intersil. The amplifiers may be AD823 made by Analog Devices. The logic chip inverters may be those designated 74HCT04 according to the standards of JEDEC. The exclusive OR gate may be those designated 74LS86 according to the standards of JEDEC. The binary converter may be those designated 74LS191 according to the standards of JEDEC and the digital to analog converter may be a AD7245A made by Analog Devices. It will be evident to those skilled in the art that the method described is not limited to the specific circuit described or to the equipment mentioned in the description. For example, other variations are possible, such as are needed to accommodate systems in which the resonant frequency of the dispensing tips is found in a different range than the one described.

1. In a capillary for dispensing microdrops of liquid by applying pressure to said liquid with a piezoelectric transducer disposed on said capillary and actuated by a voltage pulse, the improvement comprising means for measuring the voltage change produced by said transducer resulting from contact of said capillary with a surface.

2. A capillary of claim 1, wherein said produced voltage is distinguished from voltage produced by said transducer from random sources unrelated to dispensing liquids or contacting of said capillary with surfaces.

3. A capillary of claim 1 wherein said voltage produced by said piezoelectric transducer is used to prevent further contact of said capillary with a surface by stopping movement of said capillary relative to said surface.

4. In a capillary for dispensing microdrops of liquid by applying pressure to said liquid with a piezoelectric transducer disposed on a capillary and actuated by a voltage pulse, the improvement comprising means for supplying an oscillating voltage to said capillary at its resonant frequency and establishing a reference signal corresponding to the resonant frequency of said capillary and for measuring the phase shift between said capillary and said reference frequencies when said capillary contacts a surface.

5. A capillary of claim 4 wherein said phase shift resulting from contact of said capillary with a surface is used to stop movement of said capillary relative to said surface.

6. A capillary of claim 4 wherein said surface is a liquid surface.

7. A capillary of claim 6 wherein said liquid surface is a liquid droplet.

8. A capillary of claim 1 wherein said surface is a liquid surface.

9. A capillary of claim 8 wherein said liquid surface is a liquid droplet.

10. A method of detecting contact of a liquid surface by a capillary for dispensing liquid by action of a piezoelectric transducer disposed on said capillary comprising:
(a) providing an AC voltage to said capillary at a frequency corresponding to the resonant frequency of the capillary;
(b) providing the AC voltage of (a) as a reference frequency, whereby the frequencies of the capillary and the reference are in phase;
(c) detecting contact of a liquid surface by said capillary by determining the phase shift between the reference frequency of (b) and the new resonant frequency of said capillary resulting from contact of said capillary with a liquid surface; and thereafter
(d) adjusting the frequency of the AC voltage of (a) until it matches the new resonant frequency of the capillary resulting from the contact with the liquid surface.

11. A method of claim 10 where in the frequency of step (a) corresponding to the capillary and the reference frequency of step (b) are separately amplified.

12. A method of claim 11 wherein said amplifiers supply amplified analog signals to logic chip converters that convert the analog signals to square waves.

13. A method of claim 12 wherein said logic chip converters supply square waves to an exclusive OR gate where the phase relationship of the square waves are compared.

14. A method of claim 13 wherein the exclusive OR gate supplies a pulsed signal to a binary counter when the square waves are not in phase.

15. A method of claim 14 wherein the output of said binary counter is converted to an analog DC voltage.

16. A method of claim 15 wherein said analog DC voltage is supplied to a voltage controlled oscillator (VCO) that produces the AC voltage of step (a).

17. A method of claim 10 wherein said liquid surface is a liquid droplet.

18. A circuit for detecting the contact of a liquid surface by a capillary for dispensing liquid by action of a piezoelectric transducer disposed on said capillary comprising:
(a) a voltage controlled oscillator (VCO) for providing an AC voltage at the resonant frequency of said capillary;
(b) a reference amplifier for receiving and amplifying the AC voltage produced by said VCO;
(c) a signal amplifier for receiving the AC voltage produced by said VCO, said AC voltage being reduced by a resistor, said signal amplifier being connected to said capillary;
(d) logic chip converters for receiving the amplified output of said amplifiers of (b) and (c), said logic chip converters converting sine waves from said amplifiers to square waves;
(e) an exclusive OR gate for receiving and comparing the phase relationship of the square waves from the logic chip converters of (d); said OR gate producing no signal when the square waves are in phase;
(f) a binary counter for receiving the output of said OR gate and producing a pulsed output related to the output received from said OR gate;
(g) an digital-to-analog converter for converting the pulsed output of said binary counter into a DC voltage controlling said VCO.

19. A circuit of claim 18 wherein said liquid surface is a liquid droplet.
